(19) United States
(12) Patent Application Publication
(10) Pub. No.: US 2011/0182787 A1
(43) Pub. Date: Jul. 28, 2011

(54) METHOD FOR PRODUCING TITANIUM TETRACHLORIDE BY USING LOW-GRADE TITANIUM MATERIAL

(75) Inventors: Ping Lu, Sichuan (CN); Yangjun Yang, Sichuan (CN); Jiaxu Huang, Sichuan (CN); Zhuchun Chen, Sichuan (CN); Senlin Liu, Sichuan (CN); Wen Yang, Sichuan (CN)

(73) Assignees: PANGANG GROUP STEEL VANDADIUM & TITANIUM CO., LTD., Panzhihua, Sichuan (CN); PANGANG GROUP CO., LTD., Panzhihua, Sichuan (CN); PANGANG GROUP RESEARCH INSTITUTE CO., LTD., Chengdu, Sichuan (CN)

(21) Appl. No.: 13/060,299

(22) PCT Filed: Dec. 19, 2008
(86) PCT No.: PCT/CN08/73600

§ 371 Date: Apr. 14, 2011

(30) Foreign Application Priority Data
Aug. 26, 2008 (CN) 200810304181.1

(51) Int. Cl. C01G 23/02

(52) U.S. Cl. 423/69

(57) ABSTRACT

The invention provides a method for producing titanium tetrachloride by using a low grade titanium material, and belongs to the chemical field. The technical problem to be solved is to provide a method for producing titanium tetrachloride by using a low grade titanium material capable of continuous industrialized production. The method is characterized in that the low grade titanium material containing a certain proportion of titanium carbide is caused to directly react with chlorine at 600-700° to produce the titanium tetrachloride. Long-time continuous and stable operation can be realized by using the process parameters of the method, and chlorination rate of the titanium carbide in the titanium material reaches above 90%, so that the titanium material can be better used for producing the titanium tetrachloride.

### FIELD OF THE INVENTION

The invention belongs to the chemical field, and relates to a method for producing titanium tetrachloride, in particular to a method for producing titanium tetrachloride by using a low grade titanium material.

### DESCRIPTION OF THE RELATED ART

With the rapid development of the global titanium industry, titanium ore resource has become one of the key factors that restrict the titanium industry. As high grade titanium ore resources were greatly exploited in the early days of the titanium industry, the high grade titanium ore resources are getting less and less, and such high grade titanium ore resources are characterized by concentrated production places and monopolized by a small number of large groups, while low grade titanium ore resources are characterized by wide distribution, diversified occurrences and great reserves. Therefore, developing the chlorination process for the low grade titanium materials can solve the present problem of resource shortage, widely promote their application, comprehensively improve the worldwide titanium industry and increase the yield of relevant products.

Chinese Patent Application 200610021468.4 “Method for extracting iron, titanium and vanadium from high titanium-bearing ferro-vanadium concentrate” discloses a chlorination process of carbide slag of vanadium-titanium chromium, however, the process is involved with the high titanium-bearing ferro-vanadium concentrate and is incapable of achieving large-scale continuous industrial production.

Chinese Patent ZL87107488.5 “Method for preparing titanium tetrachloride by using titanium-bearing blast furnace slag” discloses a process for preparing titanium tetrachloride by using titanium-bearing blast furnace slag containing 15-30% of titanium dioxide. The process comprises the following main steps: carbonizing the titanium-bearing blast furnace slag at 1600-1800°, and preparing the titanium tetrachloride by chlorination in a fluidized bed at 250-600°, preferably 400-550°. The process is unavailable for treating raw materials with lower titanium dioxide content, and the application thereof also considers that the fluidized bed can not produce any product at temperatures over 600°.

Generally, the low grade titanium material refers to the high titanium-bearing blast furnace slag generated in producing common titanium products, or other low grade titanium materials with TiO₂ content lower than 25% in general, and shall be subject to high temperature carbonization at 1800-2000° before use. Other relevant technical report on producing the titanium tetrachloride by chlorination of the low grade titanium ores is not available at present.

At present, it is required to develop methods for producing the titanium tetrachloride by using the low grade titanium materials capable of continuous industrial production with simpler process at lower cost in the field.

### SUMMARY OF THE INVENTION

The technical problem to be solved in the invention is to provide a method for producing titanium tetrachloride by using a low grade titanium material capable of continuous industrial production. The technical proposal of the method is to cause the low grade titanium material to directly react with chlorine at 600-700° to produce the titanium tetrachloride.

The low grade titanium material contains 6%-16% of titanium carbide.

Further, the low grade titanium material contains 7%-12% of titanium carbide.

The reaction temperature at which the low grade titanium material directly reacts with the chlorine is preferably 610-650°, more preferably 640±10°.

The volume concentration of the chlorine in the method is 50%-100%, preferably 75%-85%.

The method comprises the following steps:

a. adding the low grade titanium material to a furnace, and heating to start up the furnace;
b. adding the remaining low grade titanium material when the furnace is heated to 420±40°, and introducing chlorine with the volume concentration of 50%-100% for reaction based on reaction rate according to TiC content of the low grade titanium material;
c. controlling temperature of the furnace at 600-700° as the temperature in the furnace rises slowly after the reaction starts;
d. collecting titanium tetrachloride-containing gas generated during reaction for condensation treatment to obtain liquid titanium tetrachloride and tail gas, and taking out reacted inert chloride residue based on the volume of the material added; and
e. treating and discharging the remaining residue after the reaction.

The low grade titanium material in step a of the method contains 6%-16% of titanium carbide, and further contains 7%-12% of titanium carbide.

Hot air heated by natural gas or kerosene is used in step a of the method to heat the material in the furnace to start up the furnace.

The reaction temperature at which the low grade titanium material directly reacts with the chlorine in step b of the method is controlled at 610-650°, preferably 640±10°.

The volume concentration of the chlorine in step c of the method is preferably 75%-85%. The temperature is controlled by taking part of inert chloride residue generated in the reaction out of a system for cooling and returning to the system in step c of the method, or controlled by transferring the material from the reaction furnace to an external catalyst cooler for circulating cooling. Of course, the above two method can be used at the same time.

The method for producing titanium tetrachloride by using a low grade titanium material has the advantages of being very convenient as the low grade titanium material can be caused to directly react with the chlorine at 600-700° to produce the titanium tetrachloride. The method of the invention can enable long-time continuous and stable operation and industrialization, and chlorination rate of titanium carbide in the titanium material can reach above 90%. Meanwhile, the method does not need porous reduction media such as porous carbon, thus greatly saving the cost.

### BRIEF DESCRIPTION OF THE DRAWINGS

FIG. 1 is schematic diagram of the method for producing titanium tetrachloride by using a low grade titanium material of the invention.

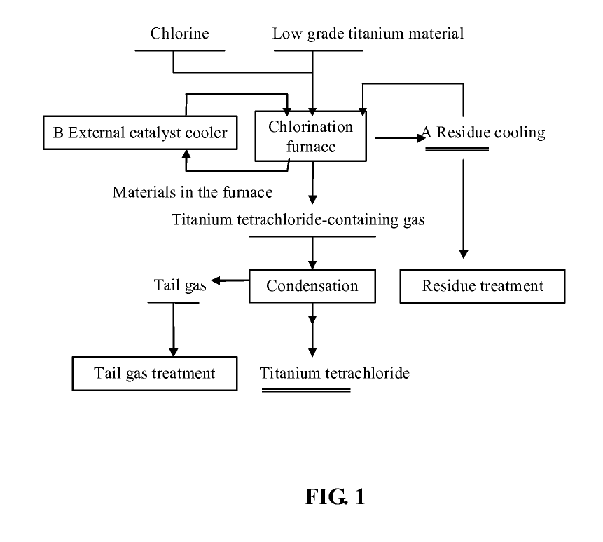

### DETAILED DESCRIPTION OF THE PREFERRED EMBODIMENTS

The invention is described in detail with reference to the following example, but is not to be limited thereto.

The low grade titanium material of the invention is from high titanium-bearing blast furnace slag or other low grade titanium materials (TiO₂ content is lower than 25%), and formed by carbonization at the high temperature of 1800-2000°. Generally, the low grade titanium material used in the invention contains 6%-16% of titanium carbide, and total titanium content (total content of titanium element in raw material, and titanium element may exist in titanium carbide, titanium dioxide, titanium trioxide, titanium nitride, etc.) is 4.8%-14%.

In the reaction, hot air from combustion of natural gas or kerosene is used to heat the material in the furnace to start up the furnace, and ⅓ of the material for the normal reaction is added to the furnace when the furnace is started up. Generally, the material is a 1:1 mixture of the low grade titanium-containing titanium carbide material to be treated and chloride residue generated during previous implementation of the process. Hot air can be changed into reaction gas at any time for reaction after the temperature in the furnace reaches 400°. The reaction gas is generally a mixture of chlorine and air, and the volume concentration of the chlorine is 50%-100%, preferably 75%-85%. The reaction gas also can be mixture of chlorine and other inert gas such as nitrogen and argon instead of air.

As chlorination reaction of the titanium carbide gives off a lot of heat during the reaction, the system temperature can not be controlled in a reasonable range if the heat is not removed in time. Therefore, the heat of the reaction system needs to be removed by a reasonable method. The method of the invention can take part of inert chloride residue generated in the reaction out of the system for cooling and returning the chloride residue to the system, thus diluting reaction heat and controlling the temperature of the reaction system. Meanwhile, the system temperature can be controlled by transferring the material from the furnace to an external catalyst cooler for circulating cooling. The two methods can be separately or jointly used accordingly. The reaction temperature is controlled at 600-700° during chlorination, preferably 610-650°, more preferably 640±10°.

The invention can be applied to boiling chlorination furnaces with diameter ranging from 50 mm to 10000 mm or even larger boiling chlorination furnaces by controlling residence time of solid materials in the furnaces and mean flow rate of gas in beds. The residence time of the solid materials is controlled at 28-60 min and the mean flow rate of gas is controlled at 0.05-0.5 m/s according to productivity requirements in specific production.

During the reaction, titanium tetrachloride-containing tail gas enters dust collection and condensation systems from the top of the chlorination furnace, fine granular furnace burden carried over by the tail gas is collected by the dust collection system, and titanium tetrachloride gas is cooled below boiling point in the condensation system, form liquid and is collected in a special storage tank. The tail gas enters a tail gas treatment system after condensation, and acid gas is vented after washing by alkali liquor. Meanwhile, the residue that is discharged from the reaction furnace and is not returned to the system enter a residue treatment system, and can be used as a raw material for producing cement after purification treatment according to the existing treatment methods.

The low grade titanium material used in the examples of the invention is from carbide slag of blast furnace slag formed by carbonization of the high titanium-bearing blast furnace slag at high temperature, and typical components of the low grade titanium material are as shown in Table 1.

TABLE 1
Typical component content of low grade titanium material

| | Component | | | | | | | | |
|---|---|---|---|---|---|---|---|---|---|
| | TiC | Al₂O₃ | CaO | MgO | MnO | SiO₂ | TFe | V₂O₅ | H₂O |
| % | 13.95 | 17.50 | 28.40 | 6.85 | 0.35 | 24.95 | 0.50 | 0.10 | ≦0.5 |

### Example 1

### Preparation of Titanium Tetrachloride by the Method of the Invention

Carbide slag of blast furnace slag (see Table 1 for typical components) and chlorine were used as reaction raw materials, and diameter of the furnace body was 200 mm.

Totally 20 kg of fresh carbide slag and chloride residue were added at 1:1 ratio to the chlorination furnace and heated. Chlorine and air were introduced at a ratio of 75% when the temperature of the materials in the furnace reached 400°, that is, chlorine charging rate was 6 m³/h, dry air charging rate was 2 m³/h, fresh material feeding rate was 30 kg/h, and residue returning rate was 10 kg/h. The residence time of the solid materials was 40 min, the temperature was controlled at 640±10°, and the system stably operated for over 8 h. The chlorination rate of the titanium carbide in the raw materials was 91%, and coarse titanium tetrachloride collected by the condensation system was 76 kg.

### Example 2

### Preparation of Titanium Tetrachloride by the Method of the Invention

Carbide slag of blast furnace slag (see Table 1 for typical components) and chlorine were used as reaction raw materials, and diameter of the furnace body was 200 mm.

Totally 20 kg of fresh carbide slag and chloride residue were added at 1:1 ratio to the chlorination furnace and heated. Chlorine and air were introduced at a ratio of 50% when the temperature of the materials in the furnace reached 400°, that is, chlorine charging rate was 4 m³/h, dry air charging rate wais 4 m³/h, fresh material feeding rate was 25 kg/h, and residue returning rate was 15 kg/h. The residence time of the solid materials was 28 min, the temperature was controlled at 610±10°, and the system stably operated for over 8 h. The chlorination rate of the titanium carbide in the raw materials was 86%, and coarse titanium tetrachloride collected by the condensation system was 63 kg.

### Example 3

### Preparation of Titanium Tetrachloride by the Method of the Invention

Carbide slag of blast furnace slag (see Table 1 for typical components) and chlorine were used as reaction raw materials, and diameter of the furnace body was 200 mm.

Totally 20 kg of fresh carbide slags and chloride residue were added at 1:1 ratio to the chlorination furnace and heated. Pure chlorine was introduced at 6 m³/h when the temperature of the materials in the furnace reached 400°. Fresh material feeding rate was 35 kg/h, and residue returning rate was 5 kg/h. The residence time of the solid materials was 42 min, the temperature was controlled at 610±10°, and the system stably operated for over 8 h. The chlorination rate of the titanium carbide in the raw materials was 84%, and coarse titanium tetrachloride collected by the condensation system was 88 kg.

### Example 4

### Preparation of Titanium Tetrachloride by the Method of the Invention

Carbide slag of blast furnace slag (see Table 1 for typical components) and chlorine were used as reaction raw materials, and diameter of the furnace body was 200 mm.

Totally 2000 kg of fresh carbide slags and chloride residue were added at 1:1 ratio to the chlorination furnace and heated. Chlorine and air were introduced at a ratio of 78% when the temperature of the materials in the furnace reached 400°, that is, chlorine charging rate was 430 m³/h, dry air charging rate was 186 m³/h, fresh material feeding rate was 4000 kg/h, and residue returning rate was 800 kg/h, and the residence time of the solid materials was 45 min. Meanwhile, an external catalyst cooler was used to cause materials in the furnace to circulate therein for heat exchange with circulating water in coils of the external catalyst cooler. The reaction temperature in the furnace was controlled at 630±10°, and the system stably operated for over 72 h. The chlorination rate of the titanium carbide in the raw materials was 90%, and coarse titanium tetrachloride collected by the condensation system was 120 t.

1-6. (canceled)

7. The method for producing titanium tetrachloride by using a low grade titanium material, said method comprising the following steps:
a. adding the low grade titanium material to a furnace, and heating to start up the furnace;
b. continuing adding the low grade titanium material when the furnace is heated to a temperature of 420±40° C., and introducing chlorine with a volume concentration of 75%-85% for reaction based on a reaction rate according to a TiC content of the low grade titanium material;
c. controlling the temperature of the furnace at 610-650° C. as the temperature in the furnace rises slowly after the reaction starts;
d. collecting titanium tetrachloride-containing gas generated during the reaction for condensation treatment to obtain liquid titanium tetrachloride and tail gas, and separating out reacted inert chloride residue based on a volume of the low grade titanium material added; and
e. treating and discharging a remaining residue after the reaction.

8. The method for producing titanium tetrachloride by using a low grade titanium material of claim 7, wherein the low grade titanium material in step a contains 6%-16% of titanium carbide.

9. The method for producing titanium tetrachloride by using a low grade titanium material of claim 8, wherein the low grade titanium material in step a contains 7%-12% of titanium carbide.

10. The method for producing titanium tetrachloride by using a low grade titanium material of claim 7, wherein hot air heated by natural gas or kerosene is used to heat the low grade titanium material in the furnace to start up the furnace in step a.

11-12. (canceled)

13. The method for producing titanium tetrachloride by using a low grade titanium material of claim 7, wherein the reaction temperature in step c is controlled by taking part of the inert chloride residue generated in the reaction out of a system for cooling and returning to the system.

14. The method for producing titanium tetrachloride by using a low grade titanium material of claim 7, wherein the reaction temperature in step c is controlled by transferring the low grade titanium material from the furnace to an external catalyst cooler for circulating cooling.
